(19) United States
(12) Patent Application Publication
(10) Pub. No.: US 2018/0052563 A1
(43) Pub. Date: Feb. 22, 2018

(54) TOUCH PANEL CONTROL DEVICE AND IN-VEHICLE INFORMATION DEVICE

(71) Applicant: MITSUBISHI ELECTRIC CORPORATION, Tokyo (JP)

(72) Inventor: Shinji FUJII, Tokyo (JP)

(73) Assignee: MITSUBISHI ELECTRIC CORPORATION, Tokyo (JP)

(21) Appl. No.: 15/558,118

(22) PCT Filed: May 28, 2015
(86) PCT No.: PCT/JP2015/065429

§ 371 Date: Sep. 13, 2017

(51) Int. Cl. G06F 3/041; G06F 3/044; B60K 37/06

(52) U.S. Cl. CPC G06F 3/0418; G06F 3/044; B60K 2350/1028; G06F 2203/04108; B60K 37/06

(57) ABSTRACT

A touch panel control device includes: a first determiner to compare a touch level value at each of coordinates along a detection surface of a touch panel, with a first threshold value, to thereby determine presence or absence of an operation for the touch panel; a second determiner to compare, when the first determiner determines the presence of the operation for the touch panel, the touch level value in the operation with a second threshold value, to thereby determine whether the operation is valid or invalid; and a threshold-value changer to change the second threshold value. When the second determiner compares the touch level value in the operation with the second threshold value and determines that the operation is valid, the threshold-value changer changes the second threshold value in the middle of the operation.

### TECHNICAL FIELD

The present invention relates to a touch panel control device for controlling a touch panel, and an in-vehicle information device provided with the touch panel control device.

### BACKGROUND ART

Heretofore, in-vehicle information devices, such as, a navigation device for guiding a vehicle along its traveling route, an audio device for playing back voice data, and the like, have been in wide-spread use. Further, a so-called “nav audio device” in which a navigation device and an audio device are integrated together has also been in wide-spread use. Furthermore, a so-called “display audio device” which cooperates with a portable information terminal, such as a smartphone or the like, to thereby serve as a navigation device, has also been developed.

The in-vehicle information device, such as a navigation device, a nav audio device, a display audio device or the like, has an FPD (Flat Panel Display) for displaying various information related to a traveling route, voice data, etc. Further, the in-vehicle information device has a touch panel integrated with the FPD, so as to receive an operation input by a user.

In general, on the touch panel of the in-vehicle information device, the user operates an object, such as a finger, in a state in proximity to or in contact with that panel. A control device for the touch panel is not just required to detect the proximity or contact of the object, but is also required to determine whether or not the proximity or contact of the object is due to a user's intentional operation, to thereby restrict any operation unintended by the user.

An electronic device of Patent Document 1 is provided with a touch panel stacked and placed on a display unit, and is configured such that, when an oblateness of a pointer-covering area in a specified plane that is apart by a specified distance from the display surface of the display unit, is less than a threshold value, an operation directed to the center coordinate of that area is made valid, and when the oblateness is more than the threshold value, an operation directed to the center coordinate of that area is made invalid. According to this configuration, in the case of a hover operation, an operation due to a user's unintentional operation is prevented.

### CITATION LIST

### Patent Document

Patent Document 1: Japanese Patent Application Laid-open No. 2014-178868

### SUMMARY OF THE INVENTION

### Technical Problem

The electronic device of Patent Document 1 determines in the hover operation on the touch panel whether the operation is valid or invalid, in accordance with the oblateness of the pointer. However, in the case of a touch panel where the pointer is operated in a state in contact therewith, the oblateness of the pointer varies for each user, and also changes in accordance with the type of operation. For example, as compared with an operation of selecting a button in the screen, in a sliding operation on the screen or an icon-dragging operation, the finger is pushed harder against the screen, so that the oblateness increases. The electronic device of Patent Document 1 cannot deal with such a change in the oblateness, and thus has a problem that it is unable to restrict a failure operation in the case of the touch panel where the pointer is operated in a state in contact therewith.

It is noted that, in Patent Document 1, such a technique is also disclosed in which a threshold value for determining a failure response is changed in accordance with a response position. However, when the threshold value is changed merely in accordance with the response position, a criterion by which the operation is determined to be valid varies for every response position on the touch panel. This causes variation in operation feeling between the respective response positions, so that there is a problem that the user feels uncomfortable with the operation, as exemplified by the case where, when the user is going to perform a dragging or like operation, for example, the dragging operation is unintentionally terminated.

This invention has been made to solve the problem as described above, and an object thereof is to provide a touch panel control device which can restrict an operation unintended by the user and can also reduce variation in operation feeling between respective regions on the touch panel. In addition, an object thereof is to provide an in-vehicle information device provided with the touch panel control device.

### Solution to Problem

A touch panel control device of the invention comprises: a first determination unit for comparing a touch level value at each of coordinates along a detection surface of a touch panel, with a first threshold value, to thereby determine presence or absence of an operation for the touch panel; a second determination unit for comparing, when the first determination unit determines the presence of the operation for the touch panel, the touch level value in the operation with a second threshold value, to thereby determine whether the operation is valid or invalid; and a threshold-value changing unit for changing the second threshold value; wherein, when the second determination unit compares the touch level value in the operation with the second threshold value and determines that the operation is valid, the threshold-value changing unit changes the second threshold value in the middle of the operation.

An in-vehicle information device of the invention comprises the above touch panel control device.

### Advantageous Effects of Invention

In the touch panel control device and the in-vehicle information device of the invention, when the operation is determined to be valid, the second threshold value provided as a criterion for determining whether the operation is valid or invalid, is changed in the middle of the operation. Thus, the respective second threshold values before change and after change are set, so that it is possible to restrict occurrence of an operation unintended by the user and also to reduce variation in operation feeling between respective regions on the touch panel.

### BRIEF DESCRIPTION OF THE DRAWINGS

FIG. 1 is a block diagram showing a main part of a touch panel control device and an in-vehicle information device, according to Embodiment 1 of the invention.

FIG. 2 is a block diagram showing an example of a hardware configuration of a control unit and the touch panel control device, according to Embodiment 1 of the invention.

FIG. 3 is a block diagram showing another example of a hardware configuration of a control unit and the touch panel control device, according to Embodiment 1 of the invention.

FIG. 4 is an illustration diagram showing examples of a first threshold value and a second threshold value before determination that an operation is valid.

FIG. 5 is an illustration diagram showing examples of a first threshold value and a second threshold value after determination that an operation is valid.

FIG. 6 is a flowchart showing operations of the touch panel control device according to Embodiment 1 of the invention.

FIG. 7 is a flowchart showing operations of the touch panel control device according to Embodiment 1 of the invention.

FIG. 8 is an illustration diagram showing other examples of a first threshold value and a second threshold value before determination that an operation is valid.

FIG. 9 is an illustration diagram showing other examples of a first threshold value and a second threshold value before determination that an operation is valid.

FIG. 10 is an illustration diagram showing other examples of a first threshold value and a second threshold value before determination that an operation is valid.

FIG. 11 is an illustration diagram showing other examples of a first threshold value and a second threshold value before determination that an operation is valid.

FIG. 12 is an illustration diagram showing other examples of a first threshold value and a second threshold value after determination that an operation is valid.

FIG. 13 is an illustration diagram showing other examples of a first threshold value and a second threshold value after determination that an operation is valid.

FIG. 14 is a block diagram showing a main part of a touch panel control device and an in-vehicle information device, according to Embodiment 2 of the invention.

FIG. 15 is a block diagram showing a main part of a touch panel control device and an in-vehicle information device, according to Embodiment 3 of the invention.

FIG. 16 is an illustration diagram showing an example of a second threshold value before determination that an operation is valid.

FIG. 17 is an illustration diagram showing an example of a second threshold value after determination that an operation is valid.

FIG. 18 is a flowchart showing operations of a touch panel control device according to Embodiment 3 of the invention.

FIG. 19 is a flowchart showing operations of the touch panel control device according to Embodiment 3 of the invention.

FIG. 20 is a block diagram showing a main part of another touch panel control device and another in-vehicle information device, according to Embodiment 3 of the invention.

### DESCRIPTION OF EMBODIMENTS

Hereinafter, for illustrating the invention in more detail, embodiments for carrying out the invention will be described in accordance with accompanying drawings.

### Embodiment 1

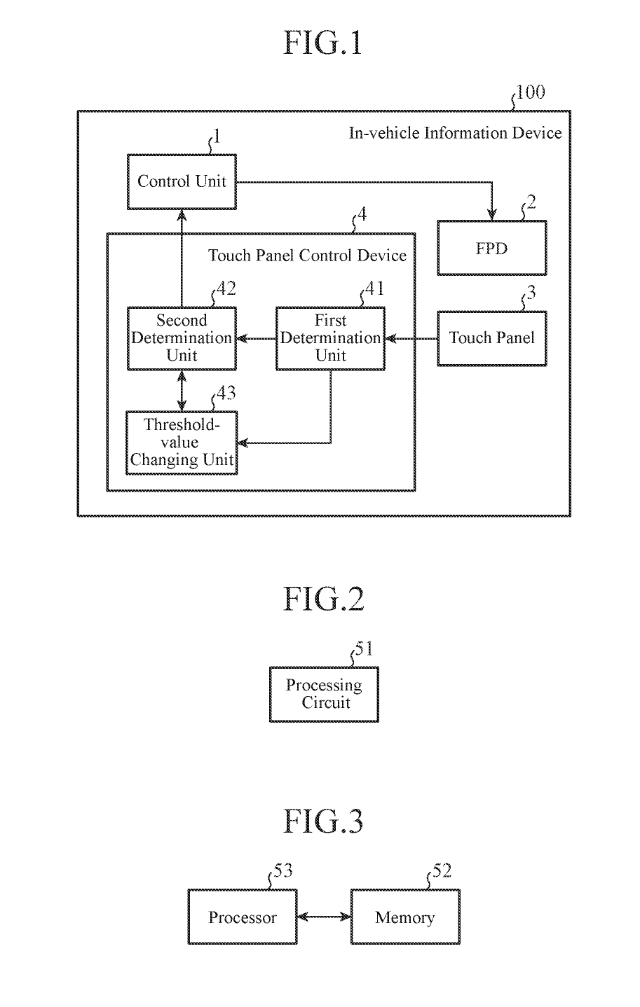

FIG. 1 is a block diagram showing a main part of an in-vehicle information device 100. As shown in FIG. 1, the in-vehicle information device 100 has a control unit 1, an FPD 2, a touch panel 3 and a touch panel control device 4. The touch panel control device 4 and the in-vehicle information device 100 according to Embodiment 1 will be described with reference to FIG. 1.

The in-vehicle device 100 is, for example, a navigation device installed in an unshown vehicle. The control unit 1 serves to execute a variety of processing, including processing for guiding the vehicle along its traveling route, set in the navigation device. Further, the control unit 1 serves to control a display screen of the FPD 2 in accordance with the content of processing that the control unit 1 itself executes.

The touch panel 3 of a so-called “capacitance type” is provided integrally with the FPD 2. Namely, the touch panel 3 has a detection surface along the display surface of the FPD 2. A plurality of electrodes is arranged along the detection surface, and a capacitance between electrodes therein changes when an object, such as a finger, is in proximity to or in contact with the detection surface.

A first determination unit 41 serves to detect an amount of change in the capacitance between the respective electrodes arranged at the coordinates on the detection surface of the touch panel 3. The first determination unit 41 serves to calculate a value indicative of the detected amount of change in the capacitance (hereinafter, referred to as “touch level value”) and then to compare that value with a first threshold value.

In the case where the touch panel 3 is put into operation in a state where the user brings an object in contact with that panel, the first threshold value is set to a value that makes it possible to recognize whether or not the object is in contact with the detection surface. Alternatively, in the case where the touch panel 3 is put into operation in a state where the user brings an object in proximity to that panel, the first threshold value is set to a value that makes it possible to recognize whether or not the object is in proximity to the detection surface. Namely, the first determination unit 41 serves to compare the touch level value at each of the coordinates with the first threshold value, thereby to determine presence or absence of an operation for the touch panel 3, and to determine the coordinate subjected to the operation on the detection surface (hereinafter, referred to as “touch coordinate”).

The first determination unit 41 is configured to determine, when at least one touch level value at a portion of the coordinates exceeds the first threshold value, that an operation for the touch panel 3 is present, and then to output the touch coordinate and the touch level value at the touch coordinate to the second determination unit 42. Further, the first determination unit 41 is configured to determine, when the touch level values at all of the coordinates are not more than the first threshold value, that an operation for the touch panel 3 is absent, and then to notifies a threshold-value changing unit 43 of that effect.

The second determination unit 42 serves to compare the touch level value at the touch coordinate outputted by the first determination unit 41, with a second threshold value, to thereby determine whether the operation directed to that coordinate on the touch panel 3 is valid or invalid. The second threshold value is a value that is set independently of the first threshold value.

The second determination unit 42 is configured to determine, when the touch level value at the touch coordinate is not more than the second threshold value, that the operation directed to that touch coordinate is invalid. Further, the second determination unit 42 is configured to determine, when the touch level value at the touch coordinate exceeds the second threshold value, that the operation directed to that coordinate is valid, and then to notify the threshold-value changing unit 43 of that effect and to output the touch coordinate and the touch level value at the touch coordinate to the control unit 1. The control unit 1 is configured to use the touch coordinate and the touch level value outputted by the second determination unit 42, thereby to execute a variety of processing set in the navigation device and to control the display screen of the FPD 2.

The threshold-value changing unit 43 serves to change each second threshold value when the operation directed to any one of the touch coordinates is determined to be valid by the second determination unit 42. Namely, the threshold-value changing unit 43 serves to set the second threshold values before and after determination by the second determination unit 42 that the operation is valid, to different values. Further, the processing of changing the second threshold value by the threshold-value changing unit 43 is executed in the middle of the operation by the user. The touch panel control device 4 is configured with the first determination unit 41, the second determination unit 42 and the threshold-value changing unit 43.

In FIG. 2, an example of a hardware configuration of the control unit 1 and the touch panel control device 4 is shown. The functions of the control unit 1, the first determination unit 41, the second determination unit 42 and the threshold-value changing unit 43 shown in FIG. 1, are implemented by a specialized processing circuit 51. The processing circuit 51 is, for example, a system LSI (Large Scale Integration), an ASIC (Application Specific Integrated Circuit), an FPGA (Field-Programmable Gate Array) or a combination thereof. Note that multiple processing circuits may instead implement these functions, in cooperation. For example, it is allowed that the function of the first determination unit 41 is implemented by a first processing unit, and the functions of the control unit 1, the second threshold unit 42 and the threshold-value changing unit 43 are implemented by a second processing circuit.

In FIG. 3, another example of a hardware configuration of the control unit 1 and the touch panel control device 4 is shown. A memory 52 serves to store programs corresponding to the respective processing steps by the control unit 1, the first determination unit 41, the second determination unit 42 and the threshold-value changing unit 43 shown in FIG. 1. The functions of the control unit 1, the first determination unit 41, the second determination unit 42 and the threshold-value changing unit 43 are implemented in such a manner that a processor 53 executes the programs stored in the memory 52. The memory 52 is, for example, a non-volatile memory, such as an EPROM (Erasable Programmable Read Only Memory), an EEPROM (Electrically Erasable Programmable Read-Only Memory), a flash memory, or the like. The processor 53 is, for example, a CPU (Central Processing Unit), an MPU (Micro-Processing Unit), a microcontroller or a DSP (Digital Signal Processor). Note that multiple processors may instead execute the programs stored in multiple memories, in cooperation, to thereby implement the above functions. For example, it is allowed that the function of the first determination unit 41 is implemented in such a manner that a first processor executes the program stored in a first memory, and the functions of the control unit 1, the second threshold unit 42 and the threshold-value changing unit 43 are implemented in such a manner that a second processor executes the programs stored in a second memory.

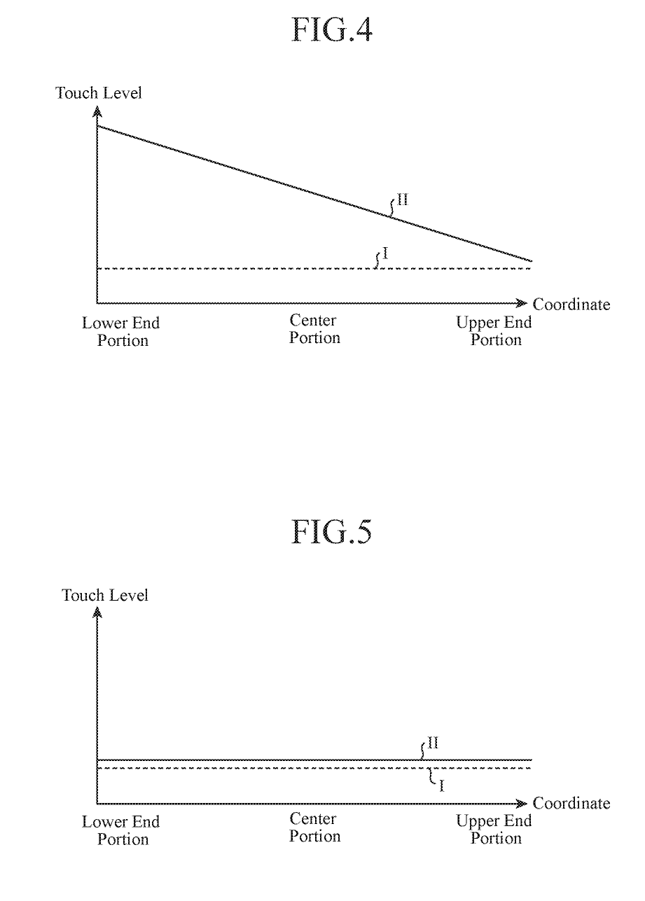

Next, examples of the first threshold value and the second threshold value will be described with reference to FIG. 4 and FIG. 5.

It is assumed that the in-vehicle information device 100 is provided in a dashboard near the driver's seat in the vehicle, and the display surface of the FPD 2 and the detection surface of the touch panel 3 are disposed in an attitude oblique to the vertical plane. Namely, the lower end portion of the display surface and the detection surface is positioned nearer to the driver's seat in the vehicle, while the upper end portion thereof is positioned farther from the driver's seat. In each of FIG. 4 and FIG. 5, there are shown the first threshold value and the second threshold value at each of the coordinates along the vertical direction of the display surface and the detection surface.

FIG. 4 shows each first threshold value I and each second threshold value II before determination by the second determination unit 42 that the operation is valid. As shown in FIG. 4, the first threshold value I is set to a constant value over the respective coordinates. The second threshold value II is set to a value that gradually increases as the position moves from the upper end portion of the display surface and the detection surface toward the lower end portion thereof. The second threshold value II at the upper end portion of the display surface and the detection surface is a value nearly equal to the first threshold value I.

FIG. 5 shows each first threshold value I and each second threshold value II after determination by the second determination unit 42 that the operation is valid. As shown in FIG. 5, the first threshold value I is set to the same value as that before determination by the second determination unit 42 that the operation is valid. The second threshold value II is set to a value nearly equal to the first threshold value I at each of the coordinates. Namely, each second threshold value II is set to the same value as the second threshold value II at the upper end portion before the determination that the operation is valid.

Next, with reference to the flowchart in FIG. 6, description will be made about operations of the touch panel control device 4, focusing on the operation of changing the second threshold value by the threshold-value changing unit 43.

In the initial state, the in-vehicle information device 100 has been powered on. The threshold-value changing unit 43 has set each second threshold value II to a value shown in FIG. 4.

First, in Step ST1, the first determination unit 41 detects an amount of change in the capacitance between the respective electrodes arranged at the coordinates on the detection surface of the touch panel 3, and then compares the touch level value with the first threshold value. The first determination unit 41 continues this processing during the in-vehicle information device 100 being powered on. When the touch level values at all of the coordinates are not more than the first threshold value (Step ST1 “NO”), the first determination unit 41 determines that an operation for the touch panel 3 is absent, and repeats such determination processing. In contrast, when at least one touch level value at a portion of the coordinates exceeds the first threshold value (Step ST1 “YES”), the first determination unit 41 determines that an operation for the touch panel 3 is present, and outputs the touch coordinate and the touch level value at the touch coordinate to the second determination unit 42.

Then, in Step ST2, the second determination unit 42 compares the touch level value outputted by the first determination unit 41 in Step ST1, with the second threshold value. When the touch level value at the touch coordinate is not more than the second threshold value (Step ST2 “NO”), the second determination unit 42 determines that the operation directed to that touch coordinate is invalid, and the processing returns to Step ST1. In contrast, when the touch level value at the touch coordinate exceeds the second threshold value (Step ST2 “YES”), the second determination unit 42 determines that the operation directed to that touch coordinate is valid. Then, the second determination unit 42 outputs the touch coordinate and the touch level value at the touch coordinate to the control unit 1 and notifies the threshold-value changing unit 43 of the effect that the operation is valid.

In Step ST3, upon receiving the notification of the effect that the operation is valid from the second determination unit 42 in Step ST2, the threshold-value changing unit 43 then changes each second threshold value from a value shown in FIG. 4 to a value shown in FIG. 5. On this occasion, the operation by the user continues, so that the processing of changing the second threshold value is executed in the middle of that operation.

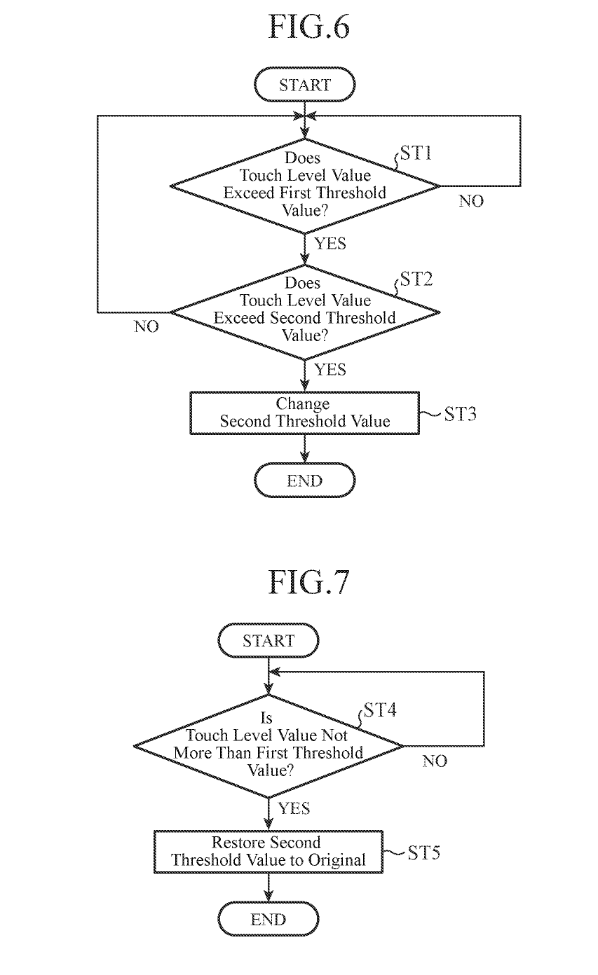

Next, with reference to the flowchart in FIG. 7, description will be made about operations of the touch panel control device 4, focusing on the operation of restoring the second threshold value changed by the threshold-value changing unit 43 to the original.

Even after Step ST3 in FIG. 6, the first determination unit 41 continues the processing of detecting an amount of change in the capacitance between the respective electrodes arranged at the coordinates on the detection surface of the touch panel 3, and then comparing the touch level value with the first threshold value. When the touch level values at all of the coordinates become the first threshold value or less (Step ST4 “NO”), the first determination unit 41 determines that an operation for the touch panel 3 is absent, and notifies the threshold-value changing unit 43 of that effect.

In Step ST5, upon receiving the notification of the effect that an operation for the touch panel 3 is absent from the first determination unit 41 in Step ST4, the threshold-value changing unit 43 restores each second threshold value from the value shown in FIG. 5 to the value shown in FIG. 4.

Next, an effect by the touch panel control device 4 will be described.

In the case where the lower end portion of the display surface of the FPD 2 and the detection surface of the touch panel 3 is positioned nearer to the driver's seat in the vehicle, while the upper end portion thereof is positioned farther from the driver's seat, when the user sitting on the driver's seat is going to operate the touch panel 3, the hand of the user will approach the detection surface from the side of the lower end of the touch panel 3. For example, when the user is going to perform an operation about the center portion of the touch panel 3 by extending his/her index finger toward that portion, such a case may arises where a part of the hand of the user other than the index finger approaches the lower half portion of the touch panel 3. On this occasion, if the touch panel were a conventional one, the touch level value in the lower half portion of the touch panel 3 will be elevated contrary to the user's intention, and this may cause a failure operation.

In contrast, in the touch panel control device 4 of Embodiment 1, before determination by the second determination unit 42 that the operation is valid, the second threshold value II is set to a value that gradually increases as the position moves from the upper end portion of the display surface and the detection surface toward the lower end portion thereof, as shown in FIG. 4. Accordingly, the nearer the coordinate is to the lower end portion of the touch panel 3, the more likely the operation is determined to be invalid if the touch level value is elevated. As a result, even when a part of the hand of the user other than the index finger approaches the lower half portion of the touch panel 3, it is possible to restrict occurrence of an operation unintended by the user.

However, the condition where each second threshold value is set to the value shown in FIG. 4, is equivalent to a condition where the sensitivity becomes lower as the position becomes closer to the lower end portion of the touch panel 3. In this condition, variation in operation feeling emerges between the respective coordinates on the detection surface, so that there is a problem that the user feels uncomfortable with the operation, as exemplified by the case where, when the user is going to perform a dragging or like operation, for example, the dragging operation is unintentionally terminated. Thus, in the touch panel control device 4 of Embodiment 1, after the operation is once determined to be valid by the second determination unit 42, the second threshold value II at each of the coordinates is changed to a constant value nearly equal to the first threshold value I, as shown in FIG. 5. This eliminates variation in operation feeling between the respective coordinates, thus making it possible to reduce uncomfortable feeling of the user.

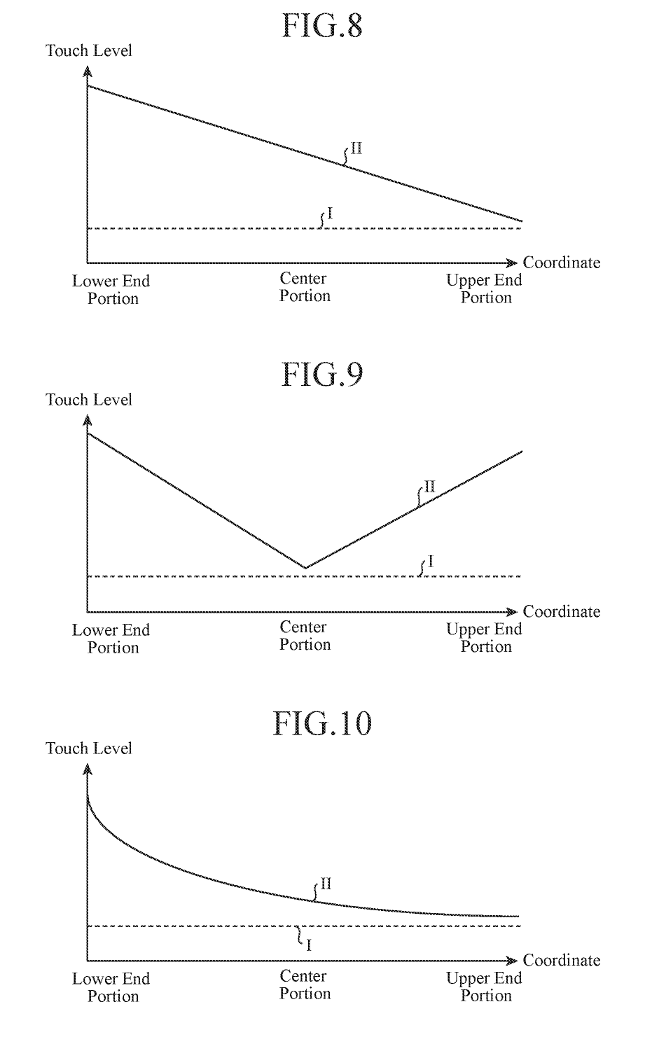

It is noted that each second threshold value before determination by the second determination unit 42 that the operation is valid, is not limited to the value shown in FIG. 4. It may be set to any value, provided that it is set differently in accordance with the coordinate on the detection surface and this makes it possible to restrict a failure operation caused by a part of the hand of the user that is unintended for his/her operation. In the following, other examples of the second threshold value will be described with reference to FIG. 8 to FIG. 11.

In the case where the in-vehicle information device 100 is provided in the dashboard between the driver's seat and the passenger's seat in a right-hand drive vehicle, when the user sitting on the driver's seat is going to operate the touch panel 3, the hand of the user will approach the detection surface from the right side of the touch panel 3. Thus, as shown in FIG. 8, the second threshold value II before determination by the second determination unit 42 that the operation is valid, is set to a value that gradually increases as the position moves from the left end portion of the display surface and the detection surface toward the right end portion thereof. This makes it possible, similarly to the example of FIG. 4, to restrict a failure operation due to the proximity of a part of the hand of the user that is unintended for his/her operation. In this case, each second threshold value II after determination by the second determination unit 42 that the operation is valid, is set to a value that is the same as the second threshold value II at the left end portion before determination that the operation is valid.

Instead, in the case where the in-vehicle information device 100 is provided in the dashboard between the driver's seat and the passenger's seat in a right-hand drive vehicle, and a screen for a user sitting on the passenger's seat is displayed on the left half portion of the display surface and a screen for a user sitting on the driver's seat is displayed on the right half portion of the display surface, the hand of the user sitting on the driver's seat will approach the right half portion of the detection surface from the right side of the touch panel 3, while the hand of the user sitting on the passenger's seat will approach the left half portion of the detection surface from the left side of the touch panel 3. Thus, as shown in FIG. 9, the second threshold value II before determination by the second determination unit 42 that the operation is valid, is set to a value that gradually increases as the position moves from the center portion of the display surface and the detection surface toward the right end portion thereof, and also gradually increases as the position moves from the center portion toward the left end portion. This makes it possible, similarly to the example shown in FIG. 4 or FIG. 8, to restrict a failure operation due to the proximity of a part of the hand of the user that is unintended for his/her operation. In this case, each second threshold value II after determination by the second determination unit 42 that the operation is valid, is set to a value that is the same as the second threshold value II at the center portion before determination that the operation is valid.

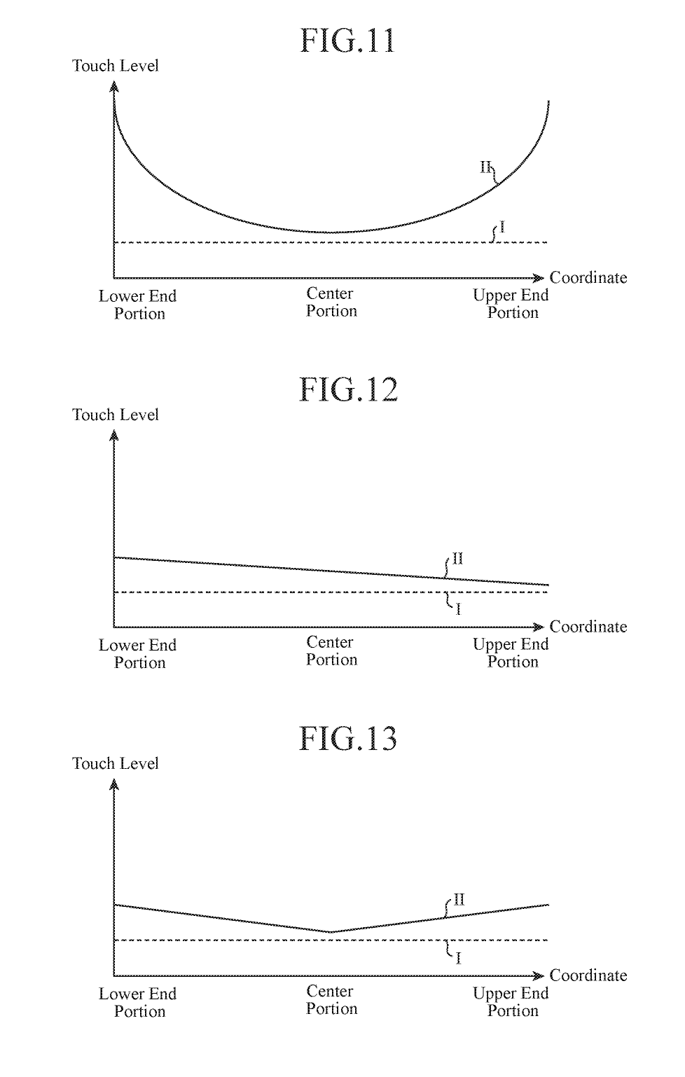

Further, the change rate of the second threshold values with respect to the coordinates is not limited to a change rate as a liner function shown in each of FIG. 4, FIG. 8 and FIG. 9. For example, it may be a change rate as a quadratic function as shown, for example, in each of FIG. 10 and FIG. 11, and may be any change rate.

Further, in each of FIG. 4 and FIG. 8 to FIG. 11, such a characteristic line of the second threshold value is shown on which the value changes along one direction that is either a vertical direction or a horizontal direction of the display surface and the detection surface; however, the second threshold values may be provided with a three-dimensional characteristic curve on which the value changes along the two directions of the vertical direction and the horizontal direction.

Further, each second threshold value after determination by the second determination unit 42 that the operation is valid, is not limited to the value that is nearly equal to the first threshold value. It may be set to any value, provided that it is made closer than the second threshold value before determination that the operation is valid, to a constant value, to thereby reduce variation in operation feeling between the respective coordinates. For example, as shown in FIG. 12, the second threshold values may be those having a change rate in touch level value with respect to the coordinates, which is made smaller in comparison with change rate of the second threshold values shown in FIG. 8. Likewise, as shown in FIG. 13, the second threshold values may be those having a change rate in touch level value with respect to the coordinates, which is made smaller in comparison with the change rate of the second threshold values shown in FIG. 9.

It is noted that the touch panel 3 is not limited to being of a capacitance type, and the touch level value is not limited to a value indicative of an amount of change in capacitance. Any type of the touch panel 3 may be used, provided that it has a detection surface along the display surface of the FPD 2 and can calculate, as a touch level value, a value corresponding to an interval between each of the coordinates on the detection surface and the object in proximity to or in contact with the detection surface.

Further, the first determination unit 41 may be that which compares the touch level value at each of the coordinates with the first threshold value to thereby determine, in addition to presence or absence of an operation for the touch panel 3, the number of regions where the touch panel 3 is subjected to an operation by the object (hereinafter, referred to as “touch-point number”). The first determination unit 41 outputs the thus-determined touch-point number to the control unit 1. The control unit 1 uses, in addition to the touch coordinate and the touch level value outputted by the second determination unit 42, the touch-point number outputted by the first determination unit 41, thereby to execute a variety of processing set in the navigation device and to control the display screen of the FPD 2.

Further, the FPD 2 and the touch panel 3 may be configured separately from the in-vehicle information device 100.

Further, the in-vehicle information device 100 may be configured by a portable information terminal, such as a smartphone, a PND (Portable Navigation Device) or the like, brought into the vehicle.

Further, the in-vehicle information device 100 is not limited to a navigation device. It may be any information device having the FPD 2 and the touch panel 3 and, for example, it may be a nav audio device or a display audio device.

Further, the information device to which the touch panel control device 4 is applied, is not limited to an information device for in-vehicle use. The touch panel control device may be applied to any information device, provided that the information device employs the FPD 2 and the touch panel 3.

As described above, the touch panel control device 4 of Embodiment 1 comprises: the first determination unit 41 for comparing the touch level value at each of the coordinates along the detection surface of the touch panel 3, with the first threshold value, to thereby determine presence or absence of an operation for the touch panel 3; the second determination unit 42 for comparing, when the first determination unit 41 determines the presence of the operation for the touch panel 3, the touch level value in the operation with the second threshold value, to thereby determine whether the operation is valid or invalid; and the threshold-value changing unit 43 for changing the second threshold value. When the second determination unit 42 compares the touch level value in the operation with the second threshold value and determines that the operation is valid, the threshold-value changing unit 43 changes the second threshold value in the middle of the operation. Before and after the operation is determined to be valid, the second threshold values are set respectively, so that it is possible to restrict occurrence of an operation unintended by the user and also to reduce variation in operation feeling between respective regions on the touch panel 3.

Further, the second threshold value before determination that the operation is valid is set to a value that varies in accordance with the coordinate on the detection surface, and the second threshold value after determination that the operation is valid is set to a value that is closer than the value before determination that the operation is valid, to the constant value. This makes it possible, before determination that the operation is valid, to restrict a failure operation caused by a part of the hand of the user that is unintended for his/her operation. On the other hand, after the operation is once determined to be valid, the second threshold value is made closer to the constant value, so that it is possible to reduce variation in operation feeling between the respective regions on the touch panel 3.

Further, the second threshold value before determination that the operation is valid, is set to a value that gradually increases as the position moves from one end portion of the detection surface toward the other end portion thereof, and the second threshold value after determination that the operation is valid, is set to a value that is the same as the second threshold value at the one end portion before determination that the operation is valid. When the second threshold value before determination that the operation is valid is set to the value shown, for example, in FIG. 4, FIG. 8 or FIG. 10, it is possible to restrict occurrence of a failure operation in the in-vehicle information device 100 in which the FPD 2 and the touch panel 3 are placed in a condition where the hand of the user will approach them from one direction.

Instead, the second threshold value before determination that the operation is valid, is set to a value that gradually increases as the position moves from the center portion of the detection surface toward an end portion thereof, and the second threshold value after determination that the operation is valid, is set to a value that is the same as the second threshold value at the center portion before determination that the operation is valid. When the second threshold value before determination that the operation is valid is set to the value shown, for example, in FIG. 9 or FIG. 11, it is possible to restrict occurrence of a failure operation in the in-vehicle information device 100 in which the FPD 2 and the touch panel 3 are placed in a condition where the hands of the users will approach them from multiple directions.

### Embodiment 2

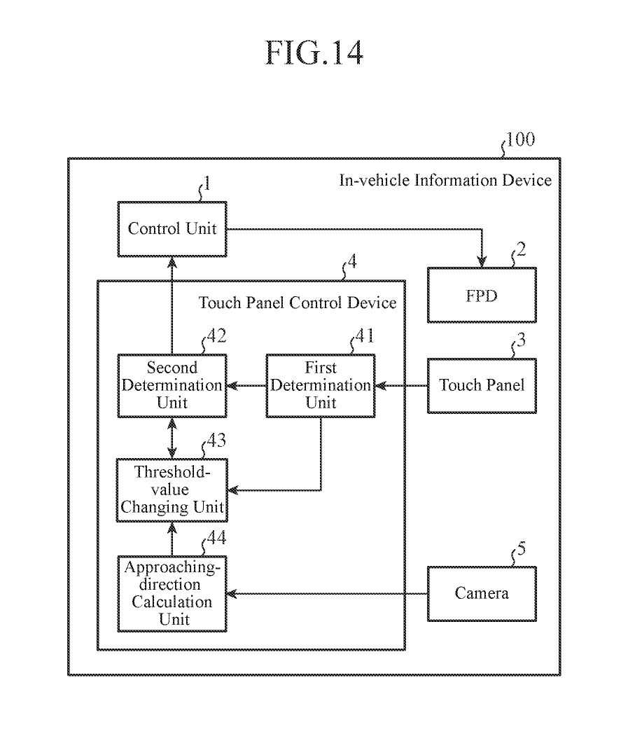

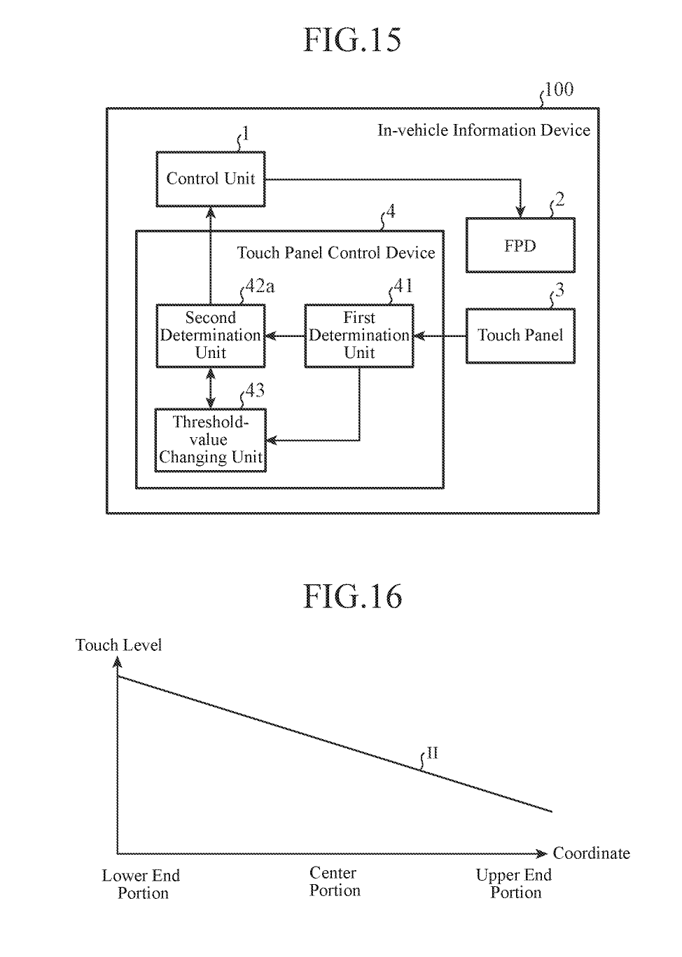

A touch panel control device 4 that detects an approaching direction of an object toward the touch panel 3 will be described with reference to FIG. 14. Note that, in FIG. 14, with respect to the blocks similar to in the block diagram of Embodiment 1 shown in FIG. 1, the same reference numerals are given thereto, so that description thereof is omitted here. Further, since the hardware configuration of a control unit 1 and the touch panel control device 4 are similar to that in Embodiment 1, description will be made while citing FIG. 2 and FIG. 3. Further, since operations of the touch panel control device 4 are similar to those in Embodiment 1, description will be made while citing FIG. 6 and FIG. 7.

As shown in FIG. 14, an in-vehicle information device 100 has a camera 5. The camera 5 is placed adjacent to the FPD 2 and can freely capture any object approaching the FPD 2 and the touch panel 3. The camera 5 is configured to output data of captured image to an approaching-direction calculation unit 44 in the touch panel control device 4.

The approaching-direction calculation unit 44 serves to execute image recognition processing on the data of image captured by the camera 5. The approaching-direction calculation unit 44 serves to detect, through the image recognition processing, an object approaching the FPD 2 and the touch panel 3, and also to calculate the approaching direction of the object toward the detection surface of the touch panel 3.

The threshold-value changing unit 43 is configured to set each second threshold value before determination by the second determination unit 42 that the operation is valid, in accordance with the approaching direction of the object calculated by the approaching-direction calculation unit 44. For example, when the hand of the user approaches the touch panel 3 from the side of its lower end, the threshold-value changing unit 43 sets each second threshold value to a value shown in FIG. 4 or FIG. 10. Instead, when the hand of the user approaches the touch panel from its right side, the threshold-value changing unit 43 sets each second threshold value to a value shown in FIG. 8. Instead, when the hands of two users approach the touch panel both from its right and left sides, respectively, the threshold-value changing unit 43 sets each second threshold value to a value shown in FIG. 9 or FIG. 11.

In this manner, each second threshold value at the initial state in FIG. 6 is dynamically set in accordance with the approaching direction of the object, so that, even when the user brings the hand close to the detection surface from any direction, it is possible to restrict a failure operation caused by a part of the hand of the user that is unintended for his/her operation.

It is noted that the camera 5 may be a camera configured separately from the in-vehicle information device 100. For example, the camera 5 which is separate from the in-vehicle information device 100 is provided in the vehicle cabin of the vehicle, to thereby capture a region including the FPD 2 of the in-vehicle information device 100. The approaching-direction calculation unit 44 executes image recognition processing on the image captured from the region including the FPD 2, to thereby calculate the approaching direction of the object.

Further, the component to be used by the approaching-direction calculation unit 44 for detecting the object is not limited to the camera 5. For example, instead of, or in addition to the camera 5, it may be or may comprise a component provided with a sensor, such as a photoelectric sensor or the like, for detecting an object approaching the touch panel 3. The approaching-direction calculation unit 44 calculates the approaching direction of the object using the detection result by the sensor.

Further, each second threshold value before determination by the second determination unit 42 that the operation is valid, is not limited to the value shown in FIG. 4, and FIG. 8 to FIG. 11. It may be set to any value, provided that the second threshold value in a region placed in the detection surface on its side where the object approaches is set to a value that is more than the second threshold value in another region therein and this makes it possible to restrict a failure operation caused by a part of the hand of the user that is unintended for his/her operation.

As described above, the touch panel control device 4 of Embodiment 2 includes the approaching-direction calculation unit 44 for calculating the approaching direction of an object toward the detection surface. Before determination by the second determination unit 42 that the operation is valid, using the calculation result by the approaching-direction calculation unit 44, the threshold-value changing unit 43 sets the second threshold value in the region placed on the touch panel 3 on its side where the object approaches, to a value that is more than the second threshold value in another region thereon. Because each second threshold value before determination that the operation is valid is set in accordance with the approaching direction of the object, even when the user brings the hand close to the touch panel 3 from any direction, it is possible to restrict a failure operation caused by a part of the hand of the user that is unintended for his/her operation.

### Embodiment 3

A touch panel control device 4 that determines whether the operation is valid or invalid on the basis of an amount of time in which the touch level value continuously exceeds the first threshold value, will be described with reference to FIG. 15. Note that, in FIG. 15, with respect to the blocks similar to in the block diagram of Embodiment 1 shown in FIG. 1, the same reference numerals are given thereto, so that description thereof is omitted here.

A second determination unit 42a serves to calculate, using the touch coordinate and the touch level value outputted by the first determination unit 41, a value indicative of the length of the time in which the touch level value continuously exceeds the first threshold value (hereinafter, referred to as “touching-time value”), for every touch coordinate. The second determination unit 42a serves to compare the calculated touching-time value with a second threshold value, to thereby determine whether the operation is valid or invalid.

The second determination unit 42a is configured to determine, when the touching-time value at a touch coordinate is not more than the second threshold value, that the operation directed to that touch coordinate is invalid. Further, the second determination unit 42a is configured to determine, when the touching-time value at a touch coordinate exceeds the second threshold value, that the operation directed to that touch coordinate is valid, and then to notify the threshold-value changing unit 43 of that effect and to output the touch coordinate and the touch level value at the touch coordinate to the control unit 1.

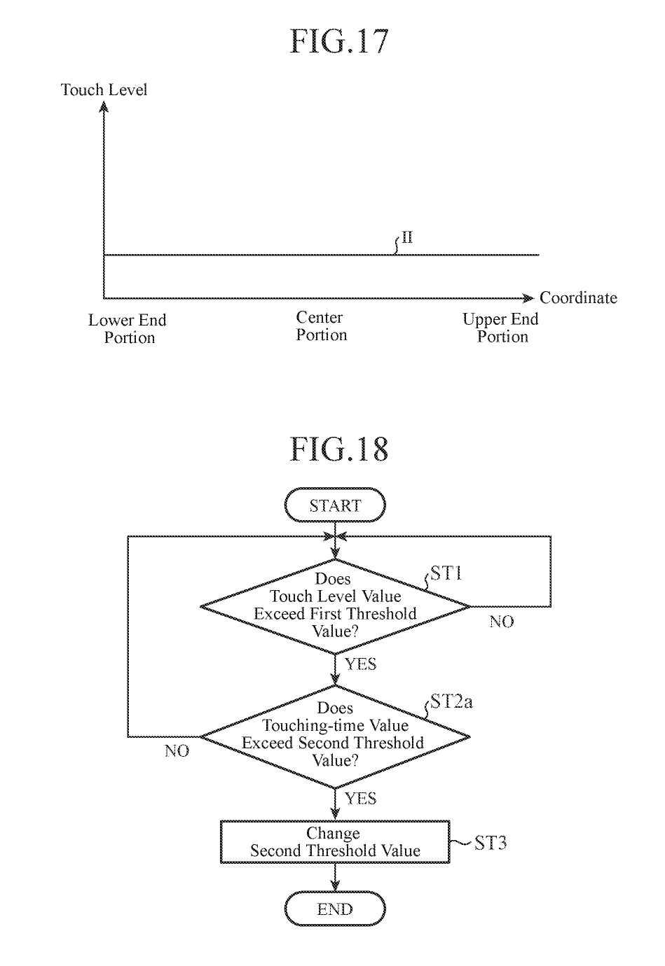

Next, examples of the second threshold value will be described with reference to FIG. 16 and FIG. 17. Note that the first threshold value is similar to in Embodiments 1 and 2, so that its description is omitted here.

It is assumed that the in-vehicle information device 100 is provided in the dashboard near the driver's seat in the vehicle, and the display surface of the FPD 2 and the detection surface of the touch panel 3 are disposed in an attitude oblique to the vertical plane. Namely, the lower end portion of the display surface and the detection surface is positioned nearer to the driver's seat in the vehicle, while the upper end portion thereof is positioned farther from the driver's seat. In each of FIG. 16 and FIG. 17, there is shown the second threshold value at each of the coordinates along the vertical direction of the display surface and the detection surface.

FIG. 16 shows the second threshold value II before determination by the second determination unit 42a that the operation is valid. As shown in FIG. 16, the second threshold value II is set to a value that gradually increases as the position moves from the upper end portion of the display surface and the detection surface toward the lower end portion thereof.

FIG. 17 shows the second threshold value II after determination by the second determination unit 42a that the operation is valid. As shown in FIG. 17, the second threshold value II is set to a constant value over the respective coordinates. Namely, each second threshold value II is set to the same value as the second threshold value II at the upper end portion before determination by the second determination unit 42a that the operation is valid.

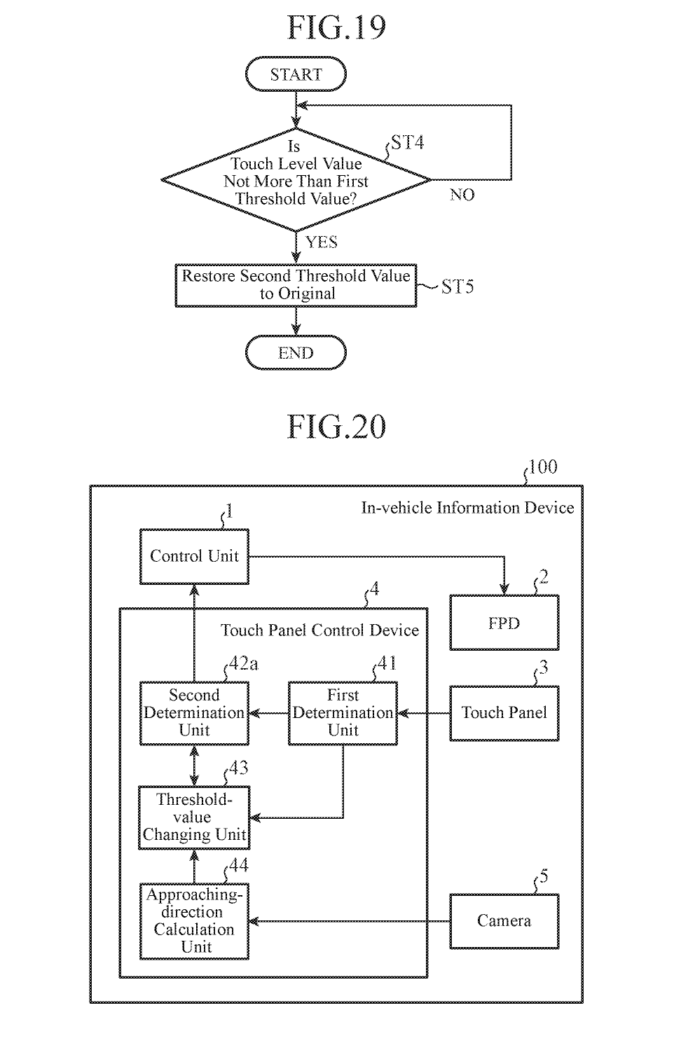

Next, with reference to the flowcharts in FIG. 18 and FIG. 19, description will be made about operations of the touch panel control device 4. Note that in FIG. 18 and FIG. 19, with respect to the steps similar to in the flowcharts of Embodiment 1 shown in FIG. 6 and FIG. 7, the same reference numerals are given thereto, so that description thereof is omitted here.

In the initial state, the in-vehicle information device 100 has been powered on. The threshold-value changing unit 43 has set each second threshold value II to a value shown in FIG. 16.

First, the first determination unit 41 executes processing in Step ST1 similar to in Embodiment 1.

Then, in Step ST2a, the second determination unit 42a measures an amount of time in which the touch coordinate and the touch level value outputted by the first determination unit 41 in Step ST1 are maintained, to thereby calculate the touching-time value, and then compares that value with the second threshold value. When the touching-time value at the touch coordinate is not more than the second threshold value (Step ST2a “NO”), the second determination unit 42a determines that the operation directed to that touch coordinate is invalid. In contrast, when the touching-time value at the touch coordinate exceeds the second threshold value (Step ST2a “YES”), the second determination unit 42a determines that the operation directed to that touch coordinate is valid. The second determination unit 42a outputs the touch coordinate and the touch level value at the touch coordinate to the control unit 1 and notifies the threshold-value changing unit 43 of the effect that the operation is valid.

In Step ST3, upon receiving the notification of the effect that the operation is valid from the second determination unit 42a in Step ST2a, the threshold-value changing unit 43 then changes each second threshold value from a value shown in FIG. 16 to a value shown in FIG. 17. On this occasion, the operation by the user continues, so that the processing of changing the second threshold value is executed in the middle of that operation.

Even after Step ST3, the first determination unit 41 continues processing similar to in Step ST1. The first determination unit 41 executes processing in Step ST4 similar to in Embodiment 1.

In Step ST5, upon receiving the notification of the effect that the operation for the touch panel 3 becomes absent from the first determination unit 41 in Step ST4, the threshold-value changing unit 43 then restores each second threshold value from a value shown in FIG. 17 to a value shown in FIG. 16.

It is noted that each second threshold value before determination by the second determination unit 42a that the operation is valid, is not limited to the value shown in FIG. 16. It may be set to any value, provided that it is set differently in accordance with the coordinate on the detection surface and this makes it possible to restrict a failure operation caused by a part of the hand of the user that is unintended for his/her operation.

Further, each second threshold value after determination by the second determination unit 42a that the operation is valid, is not limited to the value shown in FIG. 17. It may be set to any value, provided that it is made closer than the second threshold value before determination that the operation is valid, to a constant value, to thereby reduce variation in operation feeling between the respective coordinates.

Further, the touch panel control device 4 of Embodiment 3 may be that which is provided with an approaching-direction calculation unit 44 similar to in Embodiment 2. A block diagram in this case is shown in FIG. 20. Before determination by the second determination unit 42a that the operation is valid, the threshold value changing unit 43 sets each second threshold value subject to comparison with a touching-time value, in accordance with the approaching direction of the object calculated by the approaching-direction calculation unit 44.

As described above, the touch panel control device 4 of Embodiment 3 comprises: the first determination unit 41 for comparing the touch level value at each of coordinates along the detection surface of the touch panel 3, with the first threshold value, to thereby determine presence or absence of an operation for the touch panel 3; the second determination unit 42a for comparing, when the first determination unit 41 determines the presence of the operation for the touch panel 3, a touching-time value indicative of a length of a time in which the touch level value in the operation continuously exceeds the first threshold value, with the second threshold value, to thereby determine whether the operation is valid or invalid; and the threshold-value changing unit 43 for changing the second threshold value. When the second determination unit 42a compares the touching-time value in the operation with the second threshold value and determines that the operation is valid, the threshold-value changing unit 43 changes the second threshold value in the middle of the operation. Like in Embodiment 1, before and after the operation is determined to be valid, the second threshold values are set respectively, so that it is possible to restrict occurrence of an operation unintended by the user and also to reduce variation in operation feeling between respective regions on the touch panel 3.

It should be noted that unlimited combination of the respective embodiments, modification of any configuration element in the embodiments and omission of any configuration element in the embodiments may be made in the present invention without departing from the scope of the invention.

### INDUSTRIAL APPLICABILITY

The touch panel control device of the invention may be used for an information device having a touch panel. Further, the in-vehicle information device of the invention may be used for a navigation device, a nav audio device, a display audio device or the like.

### REFERENCE SIGNS LIST

1: control unit, 2: FPD, 3: touch panel, 4: touch panel control device, 5: camera, 41: first determination unit, 42, 42a: second determination unit, 43: threshold-value changing unit, 44: approaching-direction calculation unit, 51: processing circuit, 52: memory, 53: processor, 100: in-vehicle information device.

1. A touch panel control device, comprising:
a first determiner to compare a touch level value at each of coordinates along a detection surface of a touch panel, with a first threshold value, to thereby determine presence or absence of an operation for the touch panel;
a second determiner to compare, when the first determiner determines the presence of the operation for the touch panel, the touch level value in the operation with a second threshold value, to thereby determine whether the operation is valid or invalid; and
a threshold-value changer to change the second threshold value;
wherein, when the second determiner compares the touch level value in the operation with the second threshold value and determines that the operation is valid, the threshold-value changer changes the second threshold value in the middle of the operation.

2. The touch panel control device of claim 1, wherein the second threshold value before determination that the operation is valid, is set to a value that varies in accordance with the coordinate of the detection surface; and
wherein the second threshold value after determination that the operation is valid, is set to a value that is closer than the value before the determination that the operation is valid, to a constant value.

3. The touch panel control device of claim 2, wherein
the second threshold value before determination that the operation is valid, is set to a value that gradually increases as a position moves from one end portion of the detection surface toward the other end portion thereof; and
wherein the second threshold value after determination that the operation is valid, is set to a value that is the same as the second threshold value at the one end portion before determination that the operation is valid.

4. The touch panel control device of claim 2, wherein
the second threshold value before determination that the operation is valid, is set to a value that gradually increases as a position moves from a center portion of the detection surface toward an end portion thereof; and
wherein the second threshold value after determination that the operation is valid, is set to a value that is the same as the second threshold value at the center portion before determination that the operation is valid.

5. The touch panel control device of claim 2, further comprising an approaching-direction calculator to calculate an approaching direction of an object toward the detection surface;
wherein, before determination that the operation is valid, the threshold-value changer sets the second threshold value in a region placed in the detection surface on its side where the object approaches, to a value that is more than the second threshold value in another region therein.

6. An in-vehicle information device which comprises the touch panel control device of claim 1.

7. A touch panel control device, comprising:
a first determiner to compare a touch level value at each of coordinates along a detection surface of a touch panel, with a first threshold value, to thereby determine presence or absence of an operation for the touch panel;
a second determiner to compare, when the first determiner determines the presence of the operation for the touch panel, a touching-time value indicative of a length of a time in which the touch level value in the operation continuously exceeds the first threshold value, with a second threshold value, to thereby determine whether the operation is valid or invalid; and
a threshold-value changer to change the second threshold value;
wherein, when the second determiner compares the touching-time value in the operation with the second threshold value and determines that the operation is valid, the threshold-value changer changes the second threshold value in the middle of the operation.

8. An in-vehicle information device which comprises the touch panel control device of claim 7.
